(19) United States
(12) Patent Application Publication
(10) Pub. No.: US 2012/0105304 A1
(43) Pub. Date: May 3, 2012

(54) ANTENNA

(75) Inventors: Yugang Ma, Singapore Science Park II (SG); Xiaobing Sun, Singapore Science Park II (SG); Yaqiong Zhang, Singapore Science Park II (SG)

(73) Assignee: SONY CORPORATION, Tokyo (JP)

(21) Appl. No.: 13/278,783

(22) Filed: Oct. 21, 2011

(30) Foreign Application Priority Data
Oct. 28, 2010 (SG) 201008040-6

(51) Int. Cl. H01Q 1/50

(52) U.S. Cl. 343/906

(57) ABSTRACT

An antenna including one or more IC bond bands configured to connect to a signal port on an IC, one or more substrate bond pads, a bond wire antenna (BWA) connected between the one or more IC bond bands and the substrate bond pads, and a resonant cavity adjacent the one or more substrate bond pads.

### RELATED APPLICATION DATA

The present application claims priority to Singapore Patent Application 201008040-6 filed in the Singapore Patent Office on Oct. 28, 2010, the entire contents of which are hereby incorporated by reference.

### BACKGROUND OF THE INVENTION

The present invention relates to an antenna particularly though not solely to a bond wire antenna (BWA) for millimetre wave (MMW) signals.

A MMW wave antenna is often made on the printed circuit board (PCB) or other solid substrate. Due to the materials used, the loss tangent in a commercial PCB substrate in the MMW frequency band may be high. To improve efficiency, special processing on low loss material such as miniaturized electromechanical system (MEMS) processing on glass (alumina) may be used. But this may be complex and high cost.

Also the MMW signal coupling from the IC die to the substrate where the antenna is may cause additional loss. The antenna can be directly designed in the IC die (on-chip antenna) to avoid some coupling loss and greatly reduce the size. However the radiation efficiency of an on-chip antenna may be very low due to the high loss tangent of the die.

Another alternative is a bond wire on the signal port on the IC die and with a length and shape so that the bond-wire itself works as an antenna. Because the bond wire is over air, the loss of the IC die and PCB substrate has little effect to the antenna. This type of antenna is called bond-wire antenna (BWA).

In [1], a single-ended feeding BWA is proposed. In this proposal, whole antenna set is on the IC chip. It is limited to single-ended feeding application and it requires a ground plane on the top layer of the IC die. The ground plane is almost as large as whole IC die size, which might not be impractical. Moreover, because this BWA is just bonded over a ground plane, the arch height of the bond wire over the ground plane must be strictly controlled. Otherwise, the radiation efficiency, central frequency and radiation pattern could be affected.

In [2], a differential feeding triangular loop antenna is proposed. This is a combination of a BWA and an on-PCB antenna. One side of the loop is on PCB substrate and the other two sides are built by bond wires. Since the trace on the PCB substrate, this antenna's performance relies on the PCB substrate's loss tangent, dielectric constant and so on. It is more like an on-PCB antenna rather than a BWA.

In [3], a differential feeding dipole BWA is disclosed. This has narrow bandwidth plus a metal patch under the IC die.

In [5] and [6], two types of BWAs (circular polarized and linear polarized), were described. However, the antenna radiations in the previous structures may be affected by surrounding materials. And the radiation pattern may not smooth enough. This may result in a sensitive relative position between transmitter (Tx) and receiver (Rx), such that a small location inaccuracy may cause a performance loss.

### SUMMARY

In general terms the invention proposes a resonant cavity adjacent to one end of a BWA. This may have the advantage that the antenna radiation uniformity and/or the radiation directivity are improved. The side-lobe and other undesired peak of the antenna radiation pattern may be reduced, so the invention may be suitable for dual antenna duplex applications, where two antennas are close to each other and inter-antenna isolation is high. The BWA may be used in a radio frequency radiator/detector in the integrated circuit (IC) package. The substrate integrated cavity may be designed to control radiation in a MMW communication system. It may also be used in other radio frequency bands. The antenna may be compact, for example less than 0.6 mm long for a 60 GHz central frequency; and wide bandwidth, for example greater than 15 GHz for a 60 GHz central frequency.

The BWA may have 2 bond wire arms with one end on signal port on IC die and the other end on bond pads on the substrate, respectively. Under the BWA, there is a cavity in the substrate. The cavity is metal wall surrounding volume except the side having the BWA open. The cavity contains dielectric material, or nothing (vacuum), or air. The antenna central frequency may be determined by the resonant frequency of the cavity.

A dual cavity BWA structure may be used for duplex application, where two rectangular cavity BWAs are put close to each other. The resonant frequencies for the two cavities BWA can be the same or different.

The cavity shape may trapezoid, which may be suitable if the IC die area is crowded.

The cavity shape may be trapezoid and the wall close to the substrate edge may be open, which may be suitable for the environment that the IC die area is crowded, and the target direction may be horizontal.

The cavity can be a substrate integrated cavity or a metal tank.

In a first particular expression of the invention there is provided an antenna according to claim 1. Embodiments may be implemented according to any one of claims 2 to 12.

### BRIEF DESCRIPTION OF THE DRAWINGS

In order that the invention may be fully understood and readily put into practical effect there shall now be described by way of non-limitative example only, an example embodiment described below with reference to the accompanying illustrative drawings in which:

FIG. 1(a) is a perspective view of a prior art wideband BWA;

FIG. 1(b) is a graph of the radiation pattern of the BWA in FIG. 1(a);

FIG. 2(a) is a perspective view of a cavity BWA according to the example embodiment;

FIG. 2(b) is a cross section view of the cavity BWA in FIG. 2(a);

FIG. 2(c) is a graph of the radiation pattern of the cavity BWA in FIG. 2(a);

FIG. 3(a) is a top view of a 60 GHz+80 GHz rectangular cavity BWA according to a further example embodiment;

FIG. 3(b) is a graph of the loss and cross talk of the cavity BWA in FIG. 3(a);

FIG. 3(c) is a cross section view of the cavity BWA in FIG. 3(a);

FIG. 3(d) is a graph of the radiation pattern of the cavity BWA in FIG. 3(a);

FIG. 4 is a plan view of a 60 GHz+80 GHz trapezoid shape cavity BWA;

FIG. 5 is a plan view of another 60 GHz+80 GHz trapezoid shape cavity BWA;

FIG. 6 is a plan view of a 60 GHz+60 GHz cavity BWA;

FIG. 7 is a schematic drawing of an antenna measurement setup;

FIG. 8 is a graph of measured antenna gain versus frequency;

FIG. 9(a) is a graph of the measured vertical antenna radiation pattern;

FIG. 9(b) is a graph of the measured horizontal antenna radiation pattern;

FIG. 10(a) is a perspective view of a prior art dual BWA without cavities;

FIG. 10(b) is a graph of the inter-antenna isolation of the BWA in FIG. 10(a);

FIG. 11(a) is a perspective view of a dual BWA with cavities; and

FIG. 11(b) is a graph of the inter-antenna isolation of the BWA in FIG. 11.

### DETAILED DESCRIPTION

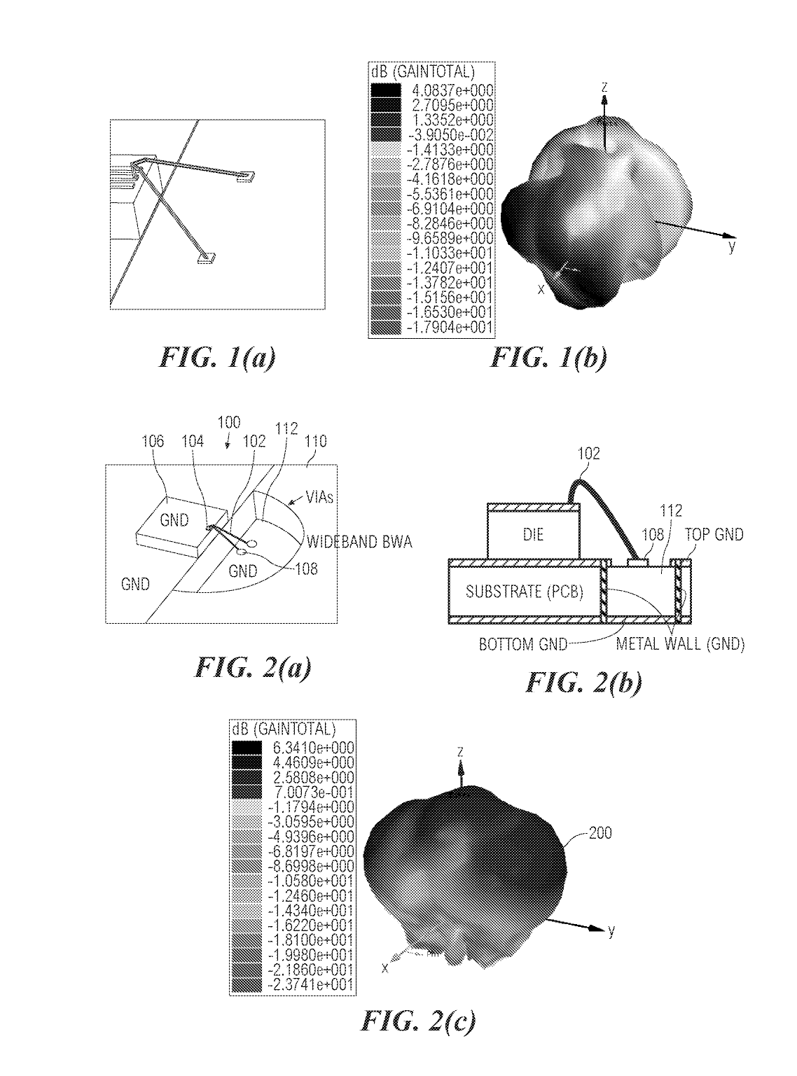

A cavity BWA 100 according to the example embodiment is shown in FIGS. 2(a) & (b). Two bond-wires 102, which are bonded at same signal port 104 on an IC die 106 and the other ends are bonded at separated bond pads 108 on the substrate 110, respectively, and a cavity 112 just below the bond pads 108. Here, the cavity is defined as 3-dimension dielectric, air or vacuum area surrounded by metal wall except one side open. The cavity 112 can be a substrate integrated cavity [8]. The substrate integrated cavity is made of 2 metal layers sandwiching a dielectric substrate (e.g. printed circuit board: PCB). At the cavity portion, one of the metal layers is etched. The area etched is the aperture of the cavity. Around the edges of the aperture, there is a vertical metal wall. The metal wall can be made of aligned through hole VIAs connecting top and bottom metal layers. The aperture size and the volume of the cavity 112 may depend on the working central frequency wavelength. For example for a 60 GHz central frequency the cavity radius may be 3 mm, thickness may be 0.8 mm, and filled material dielectric constant may be 3.7. The longer the wavelength, the bigger the cavity aperture and volume. The height of the cavity 112 may also depend on the signal wavelength. It may be better to make the thickness larger or equal to a quarter wavelength of the central signal frequency. FIG. 2(c) shows the radiation pattern 200 of the cavity BWA, we can see that the cavity BWA may have a smoother radiation pattern than that in FIG. 1(b). The cavity 112 shape shown in FIG. 2(a) is a half cylinder. It can be other shapes such as rectangular and so on. The volume of the cavity 112 may determine the central frequency of the cavity BWA.

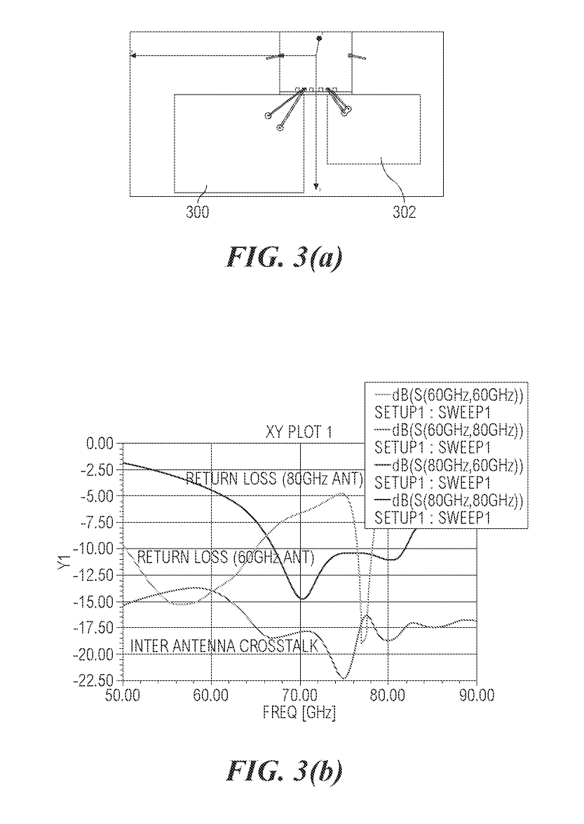

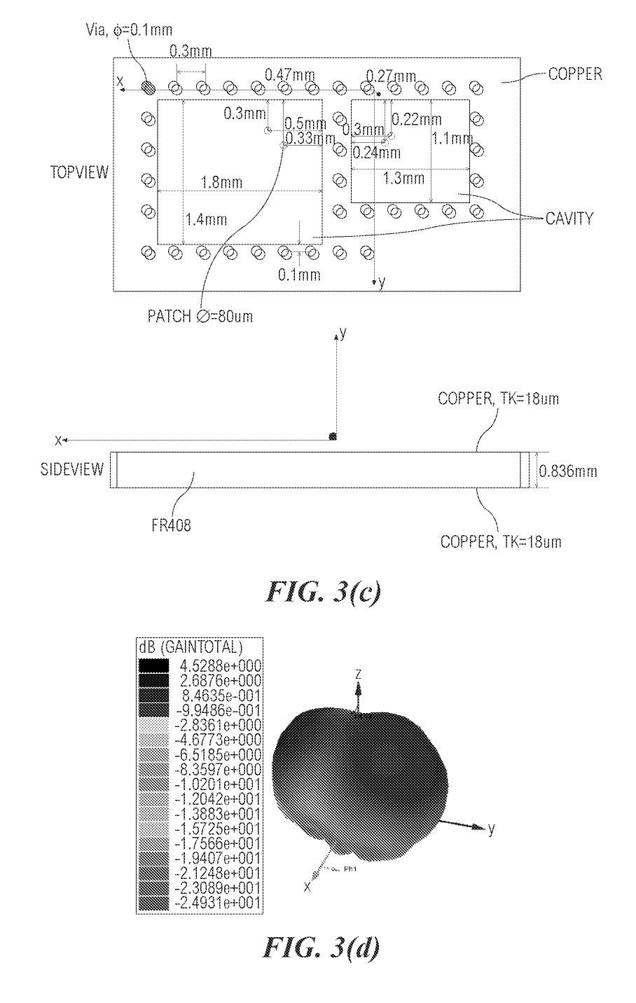

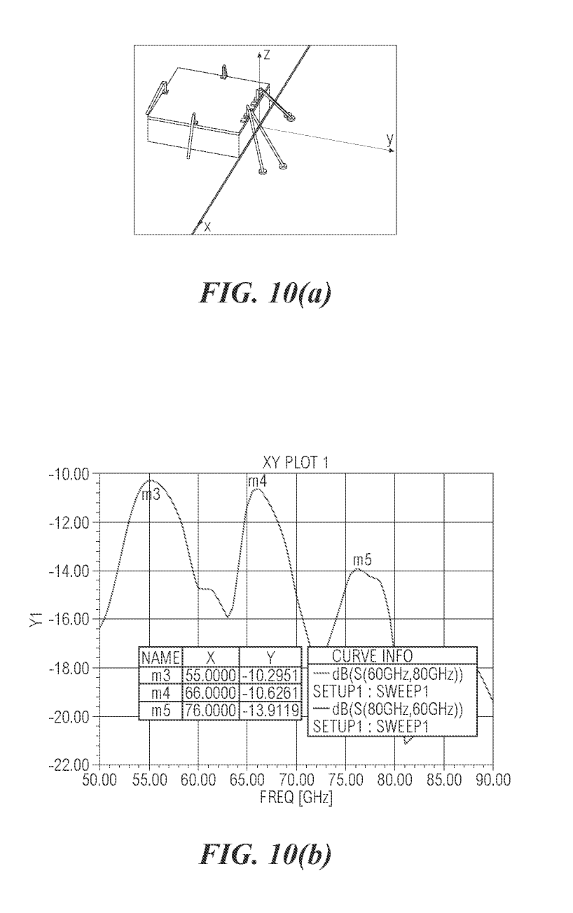

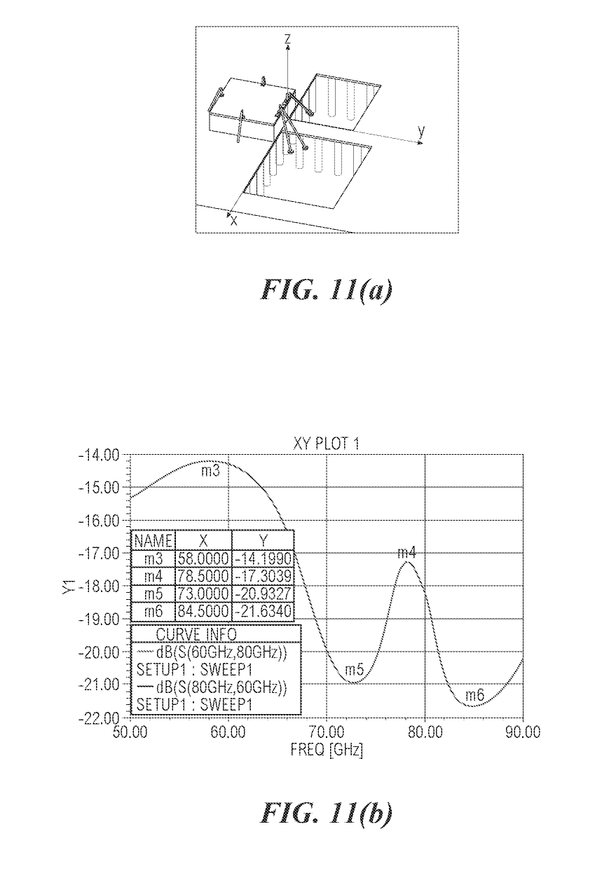

FIG. 3 shows an example of a dual 60 GHz+80 GHz cavity BWA. There are two independent rectangular cavity BWAs shown in FIG. 1. The two BWAs 300,302 are put very close to each other. Since the cavities form the antenna radiation is primarily directed upwards from the substrate. The isolation of the two cavity BWAs is improved as compared without cavities. Comparing the previous dual BWA's inter-antenna isolation in FIG. 10, and the dual cavity BWA's inter-antenna isolation in FIG. 11, we can see the new dual cavity BWA structure improved the isolation about 4 dB. Here the pitches of the signal ports on IC die and two cavity BWAs are 0.33 mm. We can see from FIG. 3(b), the return loss bandwidth of 60 GHz and 80 GHz cavity BWAs are >15 GHz. From FIG. 3(d) we can see the maximum radiation direction of the cavity BWA is upwards from the substrate.

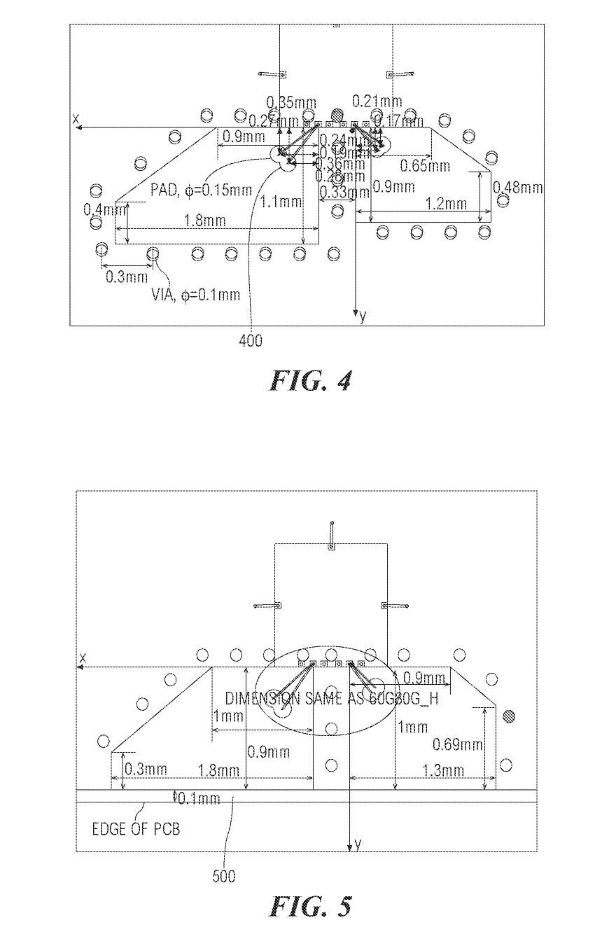

FIG. 4 shows a trapezoid shape 60 GHz+80 GHz cavity BWA, which has the same performance as shown in FIGS. 3(b) and (d). Note that the bond pads 400 in FIG. 4 are overlaid. In this variation, the cavity sides close to the IC die are small. This shape is useful in the case that the components and wire traces in the IC die area are crowded and hence there is small space allowing cavity BWA connection.

FIG. 5 is one more variation of a 60 GHz+80 GHz cavity BWA. Here, one of the cavity walls 500 near a substrate edge is removed for each BWA. This variation can direct the radiation direction of each BWA to in front of the substrate.

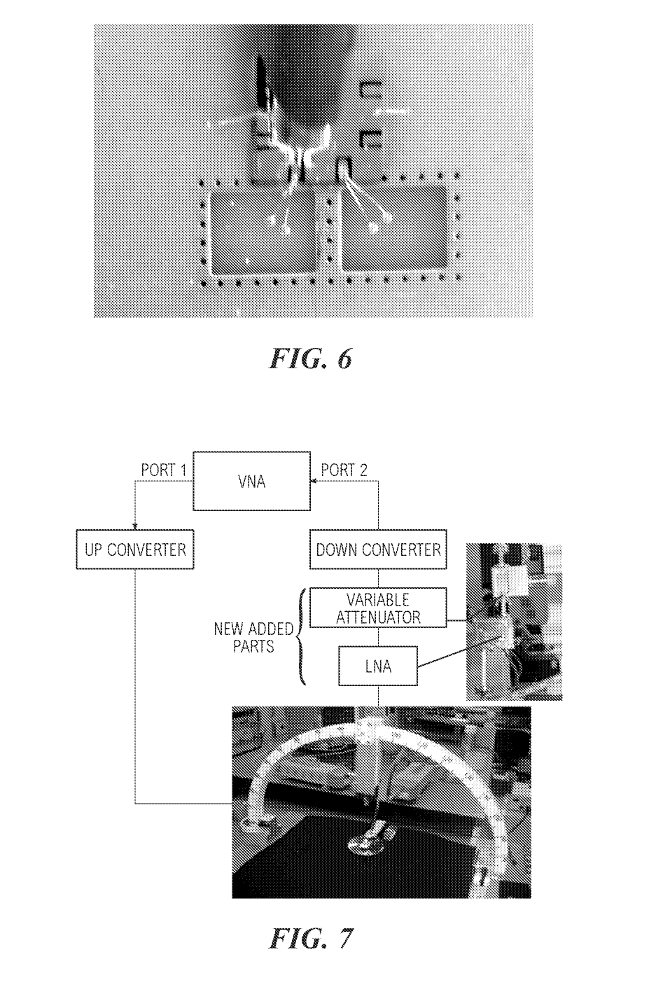

FIG. 6 is a photo of a fabricated 60 GHz+60 GHz dual cavity BWA. There is a probe of the vector attached at the BWA feeding port. It is for signal feeding and measurement.

FIG. 7 shows a antenna measurement setup for the BWA in FIG. 6. It consists of the rotation arm for test antenna gain in different directions (radiation pattern), vector network analyzer, standard horn antenna, the antenna under test and so on.

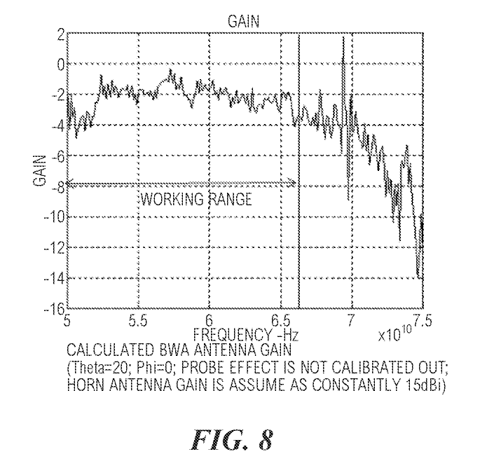

FIG. 8 shows the example measured gain versus frequency performance of a 60 GHz cavity BWA in FIG. 6. We can see the antenna frequency response is wide. From 50 GHz to 67 GHz, the antenna gain difference is <3 dBi.

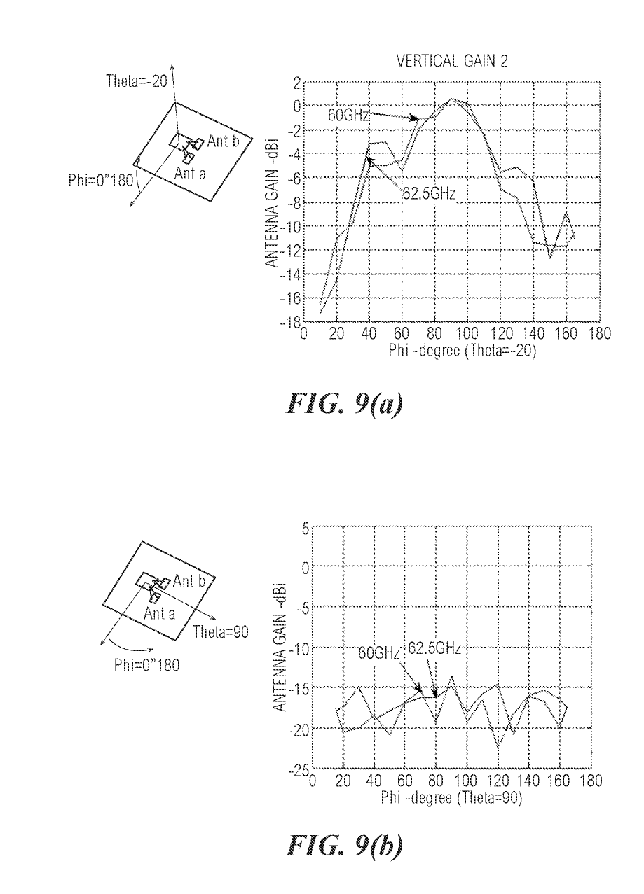

FIG. 9 shows the measured radiation pattern of the 60 GHz cavity BWA in FIG. 6. We can see that the maximum antenna gain is clear and it is to the up-direction.

While various example embodiments have been described in the detailed description, it will be understood by those skilled in the technology concerned that many variations in details of design, construction and/or operation may be made without departing from the scope as claimed.

What is claimed is:

1. An antenna comprising
an IC bond band(s) configured to connect to a signal port on an IC,
a substrate bond pad(s),
a bond wire antenna (BWA) connected between the IC bond band(s) and the substrate bond pad(s), and
a resonant cavity adjacent the substrate bond pad(s).

2. The antenna in claim 1 wherein the cavity is a shape selected from the group consisting of a half cylinder, a cube, a trapezoidal prism, and any combination thereof.

3. The antenna in claim 1 wherein the cavity is a substrate integrated cavity or a metal tank.

4. The antenna in claim 3 wherein the cavity is formed in a substrate, the substrate having a dielectric sandwiched between two metal layers, and the cavity having metal walls.

5. The antenna in claim 1 further comprising a second BWA and a second resonant cavity adjacent the second BWA.

6. The antenna in claim 1 wherein a wall of the cavity is open and configured to direct radiation is a horizontal plane.

7. The antenna in claim 1 wherein the cavity is selected from the group consisting of a dielectric, air and a vacuum.

8. The antenna in claim 1 wherein the height of the cavity is greater than or equal to a quarter of the central signal frequency wavelength.

9. The antenna in claim 1 wherein the volume of the cavity is approximately proportional to the central frequency wavelength.

10. The antenna in claim 9 wherein the BWA comprises two bond wires juxtaposed at a spanning angle, and one or more dimensions of the cavity depend on the spanning angle.

11. The antenna in claim 1 wherein the substrate bond pads are spaced or overlapping.

12. The antenna in claim 1 configured to radiate millimetre wave (MMW) signals.
